(19) United States
(12) Patent Application Publication
(10) Pub. No.: US 2008/0124266 A1
(43) Pub. Date: May 29, 2008

(54) Alumina compound sintered compact, spark plug using the same and method of manufacturing alumina compound sintered compact

(75) Inventors: Itsuhei Ogata, Okazaki-shi (JP); Yasuki Aoi, Gifu-shi (JP); Hirofumi Suzuki, Kuwana-shi (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city (JP); NIPPON SOKEN, INC., Nishio-city (JP)

(21) Appl. No.: 11/984,428

(22) Filed: Nov. 16, 2007

(30) Foreign Application Priority Data
Nov. 23, 2006 (JP) 2006-316394

(51) Int. Cl. H01T 13/32; C01F 17/00; C01F 7/00

(52) U.S. Cl. 423/263; 313/141; 423/600

(57) ABSTRACT

An alumina compound sintered compact, having a principal component of alumina, a method of manufacturing the same, and a spark plug employing such an alumina compound sintered compact are disclosed. The alumina compound sintered compact contains alumina, mullite, zircon, zirconia and a specified metal oxide composed of an oxide of at least one element selected from Group III elements excepting Mg, Ca, Sr, Ba and actinoid, wherein the alumina compound sintered compact contains 0.5 to 10 total parts by weight of mullite, zircon and zirconia, 0.5 to 10 parts by weight of the specified metal oxide and a balance of substantially alumina based on 100 parts by weight in total. The spark plug for an internal combustion engine includes a porcelain insulator made of the alumina compound sintered compact.

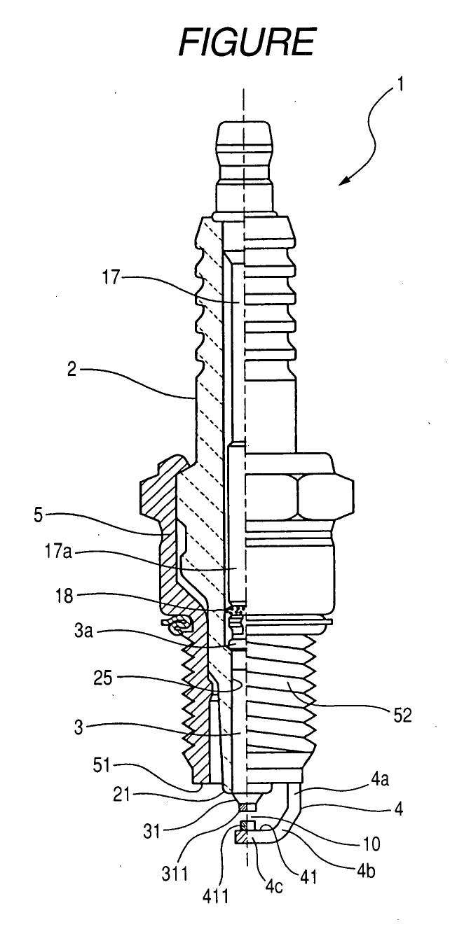

### CROSS REFERENCE TO RELATED APPLICATIONS

This application is based on Japanese Patent Application No. 2006-316394, filed on Nov. 23, 2006, the content of which is hereby incorporated by reference.

### BACKGROUND OF THE INVENTION

1. Field of the Invention

The present invention relates to an alumina compound sintered compact, a spark plug using the same for use in an internal combustion engine and a method of manufacturing an alumina compound sintered compact.

2. Description of the Related Art

An alumina sintered compact, containing alumina in major proportion, has excellent insulation and withstanding voltage properties. Therefore, the alumina sintered compact has heretofore been used as insulation material of, for instance, a spark plug for an internal combustion engine, an engine component part and an IC substrate or the like.

In the elated art, as such an alumina sintered compact, there has been known a SiO₂—MgO—CaO-based alumina sintered compact containing alumina (Al₂O₃) in major proportion (see Japanese Patent No. 2564842).

The alumina sintered compact is extremely stable in thermal and chemical characteristics with excellent mechanical strength. Thus, the alumina sintered compact has been widely put into practical use as electrical insulation material of the spark plug for the internal combustion engine.

However, the alumina sintered compact has been manufactured adding sintering additive such as magnesium oxide (MgO), calcium oxide (CaO) and silicon oxide (SiO₂) or the like with a view to providing improved sintering property. During a sintering process, the sintering additive has resulted in a liquid phase at a low melting point. Upon completion of the sintering process, an alumina grain boundary had a fear of the liquid phase being formed in a glass phase occurring with a low withstanding voltage. Thus, such an alumina sintered compact had a limit in increasing the withstanding voltage.

In recent years, more particularly, with development of an engine providing a high output in a miniaturized structure, an internal combustion engine, for use in a motor vehicle or the like, has been developed in a structure with a combustion chamber provided with intake and exhaust valves having increasingly occupied surface areas. Thus, an increasing need has been arisen for the spark plug, operative to ignite an air fuel mixture, to be miniaturized in structure with a narrow diameter. With development of the spark plug in such a narrow diameter, a need has been arisen to minimize a wall thickness of a porcelain insulator intervening between a center electrode and a mounting metal shell with a requirement of the alumina sintered compact having a further increased withstanding voltage.

### SUMMARY OF THE INVENTION

The present invention has been completed with the above view in mind and has an object to provide an alumina compound sintered compact with an excellent withstanding voltage characteristic, a related manufacturing method and a spark plug using such an alumina compound sintered compact.

To achieve the above object, a first aspect of the present invention provides an alumina compound sintered compact containing alumina as a principal component, comprising: alumina, mullite (3Al₂O₃.2SiO₂), zircon (ZrSiO₄), zirconia (ZrO₂) and a the specified metal oxide composed of an oxide of at least one element selected from Group III elements excepting Mg (magnesium), Ca (calcium), Sr (strontium), Ba (barium) and actinoid; wherein the alumina compound sintered compact contains 0.5 to 10 total parts by weight of mullite, zircon and zirconia, 0.5 to 10 total parts by weight of the specified metal oxide and a balance of substantially alumina based on 100 parts by weight in total.

The alumina compound sintered compact, containing the specified metal oxide, has the total content of mullite, zircon and zirconia mentioned above and content of the specified metal oxide. This enables the alumina compound sintered compact to obtain an excellent withstanding voltage characteristic.

Although it's uncertain exactly why the alumina compound sintered compact can obtain such an excellent withstanding voltage characteristic, the reason can be considered as, for instance, described below.

In manufacturing the alumina compound sintered compact, a sintering process is conducted during which the specified metal oxide is uniformly dispersed in mullite created upon reaction between alumina and zircon. This allows a grain boundary phase to be crystallized in an area between neighboring alumina crystal grains, causing mullite, zircon and the specified metal oxide to be formed in crystals. The crystals appearing in the grain boundary phase are formed in crystal phases each with a high withstanding voltage.

In addition, the specified metal oxide reacts with zircon thereby forming tetragonal zirconia. This precludes the occurrence of cracking caused by a phase transformation occurring during the sintering, thereby enabling a dense alumina compound sintered compact to be obtained.

As a result, the alumina compound sintered compact has an internal structure with no defects, thereby ensuring the alumina compound sintered compact to have an increased withstanding voltage.

Selecting the total of mullite, zircon and zirconia and the content of the specified metal oxide to be 0.5 to 10 parts by weight, respectively, per 100 total parts of the alumina compound sintered compact prevents mullite, zircon, zirconia and the specified metal oxide from forming independently coagulated crystals with these crystal grains being uniformly dispersed. As a result, no electrically conducting path can be formed in the alumina compound sintered compact, thereby ensuring an increased withstanding voltage.

With the alumina compound sintered compact, if the total of mullite, zircon and zirconia is less than 0.5 parts by weight, then, no adequate effect resulting from adding these substances can be obtained with a fear of a difficulty occurring in sufficiently improving the withstanding voltage characteristic. On the contrary, if the total of mullite, zircon and zirconia exceeds a value of 10 parts by weight, these substances are liable to form independently coagulated crystals, resulting in a fear of a drop occurring in the withstanding voltage characteristic.

Further, if the specified metal oxide is less than 0.5 total parts by weight, then, no adequate effect resulting from adding such a substance can be obtained with a fear of a difficulty occurring in sufficiently improving the withstanding voltage characteristic. On the contrary, if the specified metal oxide exceeds 10 total parts by weight, then, the specified metal oxide is liable to form independently coagulated crystals, resulting in a fear of a drop occurring in the withstanding voltage characteristic.

As set forth above, the present invention makes it possible to obtain the alumina compound sintered compact having an excellent withstanding voltage characteristic.

A second aspect of the present invention provides a spark plug for an internal combustion engine which spark plug employs the alumina compound sintered compact, defined in the first aspect of the present invention, as insulation material.

With the second aspect of the present invention, the spark plug incorporates insulation material with excellent withstanding voltage. The incorporation of such insulation material enables the porcelain insulator of the spark plug to be formed in a thinned wall. This enables the spark plug to be miniaturized in structure.

A third aspect of the present invention provides a spark plug for an internal combustion engine, having a metal shell having an outer circumferential periphery formed with a mounting threaded portion, a porcelain insulator fixedly secured to the metal shell, a center electrode fixedly supported in the porcelain insulator and having a leading end portion protruding from the porcelain insulator, and a ground electrode bonded to the metal shell and having a leading end placed in face-to-face relationship with the leading end portion of the center electrode to provide a spark discharge gap; wherein the mounting threaded portion has a nominal diameter less than M10; and wherein the porcelain insulator is composed of the alumina compound sintered compact according to the first aspect of the present invention.

With the spark plug of such a structure, the alumina compound sintered compact is employed as insulation material having an excellent withstanding voltage. Therefore, even if the spark plug employs a thinned porcelain insulator, the spark plug can have an adequate withstanding voltage characteristic. This provides an ease of miniaturizing the porcelain insulator, making it to provide an ease of miniaturizing the spark plug.

In addition, the mounting threaded portion has a nominal diameter less than M10. Even with a miniaturized spark plug formed in such a narrow diameter, the spark plug can have the adequate withstanding voltage characteristic, enabling the miniaturization in structure.

As set forth above, the third aspect of the present invention enables the provision of a miniaturized spark plug with an excellent withstanding voltage characteristic.

A fourth aspect of the present invention provides a method of manufacturing an alumina compound sintered compact having a principal component of alumina, comprising the steps of: preparing alumina raw material in a major component, zircon raw material, and raw material of the specified metal oxide representing an oxide of at least one element selected from Group III elements excepting Mg, Ca, Sr, Ba and actinoid; dispersing and mixing the raw materials in dispersion medium for preparing raw material mixture slurry; granulating the raw material mixture slurry to be formed in granulated objects; firing the granulated objects at temperatures equal to and above 1300° C. and equal to and less than 1600° C. for thereby obtaining the alumina compound sintered compact composed of alumina, mullite, zircon, zirconia and the specified metal oxide.

The fourth aspect of the present invention makes it possible to manufacture an alumina compound sintered compact with an excellent withstanding voltage characteristic.

Although it's not known exactly why the alumina compound sintered compact, obtained by the manufacturing method of the present invention, has an excellent withstanding voltage characteristic, the reason can be considered as, for instance, described below.

In the method of manufacturing the alumina compound sintered compact, the specified metal oxide is uniformly dispersed in mullite created upon reaction between alumina and zircon with resultant formation of neighboring alumina crystal grains between which grain boundary phases are crystallized during a sintering process. This results in the formation of mullite, zircon and the specified metal oxide. The crystals on these grain boundary phases form crystal phases with high withstanding voltages. In addition, the specified metal oxide reacts with zircon thereby forming tetragonal zirconia. This precludes the occurrence of cracking caused by a phase transformation occurring during the sintering, thereby enabling a dense alumina compound sintered compact to be obtained.

As a result, the alumina compound sintered compact has an internal structure with no defects, thereby ensuring the alumina compound sintered compact to have increased withstanding voltage.

In particular, the sintering conducted at the temperatures ranging from 1300° C. to 1600° C. precludes mullite, zircon, zirconia and the specified metal oxide from being formed in independently coagulated crystals with these crystal grains being uniformly dispersed.

With the fourth aspect of the present invention, if the granulated objects, resulting from granulating and shaping the raw material mixture slurry, are fired at temperatures less than 1300° C., raw material grains are inadequately fired, causing defective sites such as pores or the like to remain in the alumina compound sintered compact. Such defective sites cause a drop to occur in a withstanding voltage of the alumina compound sintered compact. In contrast, if the granulated objects are fired at temperatures greater than 1600° C., then, there is a fear of mullite, zircon, zirconia and the specified metal oxide being independently formed in coagulated crystals. Thus, a difficulty is encountered in uniformly dispersing the crystal grains. As a result, an electrically conductive path is formed in the alumina compound sintered compact, causing a difficulty of ensuring a high withstanding voltage.

As set forth above, the fourth aspect of the present invention can provide a method of manufacturing an alumina compound sintered compact with an excellent withstanding voltage characteristic.

A fifth aspect of the present invention provides an alumina compound sintered compact containing alumina as a principal component, comprising: alumina, mullite, zircon, zirconia and the specified metal oxide composed of an oxide of at least one element selected from Group III elements excepting Mg, Ca, Sr, Ba and actinoid; wherein the alumina compound sintered compact contains 0.5 to 10 total parts by weight of mullite, zircon and zirconia, 0.5 to 10 total parts by weight of the specified metal oxide and a balance of substantially alumina based on 100 parts by weight in total; and wherein the specified metal oxide is uniformly dispersed in mullite, resulting from a reaction between alumina and zircon, to form a grain boundary phase between neighboring alumina crystal grains in a crystal phase while forming crystals of mullite, zircon and the specified metal oxide.

With the alumina compound sintered compact containing alumina of the fifth aspect of the present invention, the specified metal oxide is uniformly dispersed in mullite, resulting from a reaction between alumina and zircon, to form a grain boundary phase between neighboring alumina crystal grains in a crystal phase while forming crystals of mullite, zircon and the specified metal oxide. These crystals in the grain boundary phase have an excellent withstanding voltage. Further, mullite, zircon, zirconia and the specified metal oxide are prevented from forming independently coagulated crystal phases. In addition, the specified metal oxide reacts with zircon, thereby forming tetragonal zirconia. This prevents the occurrence of cracking in the alumina compound sintered compact that would be caused in a phase transformation during a sintering process.

### BRIEF DESCRIPTION OF THE DRAWINGS

FIGURE is a half cross-sectional view showing an overall structure of a spark plug for an internal combustion engine to which the present invention is applied.

### DETAILED DESCRIPTION OF THE PREFERRED EMBODIMENTS

Now, an aluminum compound sintered compact, a related manufacturing method and a spark plug for an internal combustion engine employing such an aluminum compound sintered compact as insulation material are described below in detail with reference to the accompanying drawings. However, the present invention is construed not to be limited to such an embodiment described below and technical concepts of the present invention may be implemented in combination with other known technologies or the other technology having functions equivalent to such known technologies.

According to the present invention, there is provided an alumina compound sintered compact containing alumina as a principal component, comprising alumina, mullite (3Al₂O₃.2SiO₂), zircon (ZrSiO₄), zirconia (ZrO₂) and a the specified metal oxide composed of an oxide of at least one element selected from Group III elements excepting Mg (magnesium), Ca (calcium), Sr (strontium), Ba (barium) and actinoid. The alumina compound sintered compact contains 0.5 to 10 total parts by weight of mullite, zircon and zirconia, 0.5 to 10 total parts by weight of the specified metal oxide and a balance of substantially alumina based on 100 parts by weight in total.

As used herein, the term “the specified metal oxide” refers to an oxide of at least one element selected from Group III elements excepting Mg (magnesium), Ca (calcium), Sr (strontium), Ba (barium) and actinoid in an expedient manner.

With the alumina compound sintered compact, the specified metal oxide includes at least one element selected from the group consisting of MgO, CaO, SrO, BaO, Sc₂O₃, Y₂O₃, La₂O₃, CeO₂, Pr₂O₃, Pr₆O₁₁, Nd₂O₃, Pm₂O₃, Sm₂O₃, Eu₂O₃, Gd₂O₃, Tb₂O₃, Dy₂O₃, Ho₂O₃, Er₂O₃, Tm₂O₃, Yb₂O₃ and Lu₂O₃.

In this case, the alumina compound sintered compact can be provided in a structure with an excellent withstanding voltage characteristic.

With the alumina compound sintered compact, alumina crystal grains, mullite crystal grains, zircon crystal grains, zirconia crystal grains and crystal grains of the specified metal oxide are uniformly dispersed in the alumina compound sintered compact. The alumina compound sintered compact has a cross section including an arbitrary region with a surface of 100 μm×100 μm regarded as an analyzing surface. Cross-sectional areas of respective fine grains of the specified metal oxide, contained in at least the neighboring analyzing surfaces at 20 points, are measured for calculating an average cross-sectional area. The average cross-sectional area is then converted to a circle in an equal surface area with a diameter representing an equivalent circle diameter ranging from 0.2 to 4 μm.

In this case, the alumina compound sintered compact can be obtained with an excellent withstanding voltage characteristic in a further reliable manner.

That is, with the specified metal oxide with the equivalent circle diameter ranging from 0.2 to 4 μm, the specified metal oxide is dispersed in the alumina compound sintered compact under an adequately and uniformly dispersed state. With such a dispersed state, the alumina compound sintered compact can have the effect resulting from the addition of the specified metal oxide, enabling the excellent withstanding voltage characteristic of the alumina compound sintered compact to be effectively improved.

With the specified metal oxide crystallized in the grain with the equivalent circle diameter less than 0.2 μm, it becomes hard to obtain an adequate effect arising from the addition of the specified metal oxide. This results in a fear of a difficulty occurring in effectively improving the withstanding voltage characteristic of the alumina compound sintered compact. On the contrary, with the specified metal oxide crystallized in the grain with the equivalent circle exceeding 4 μm, the specified metal oxide is liable to form independently coagulated crystals, causing a drop in the withstanding voltage characteristic of the alumina compound sintered compact.

Moreover, for instance, arbitrary 100 pieces of fine grains are observed using a transmission electron microscopy (TEM) to measure grain diameters upon which an average value of the measured values is calculated to obtain an equivalent circle diameter. In a case where the specified metal oxide is formed in a fine grain with a sphere shape, the diameter of the fine grain represents a grain diameter. If the specified metal oxide is crystallized in a fine grain formed in the other shape than the sphere shape, then, an image processing is taken to measure a projected are of the crystal grain upon which a diameter of a circle corresponding to the projected area is calculated, thereby obtaining an equivalent circle diameter.

A cross sectional area of the crystal grain appearing in the analyzing surface can be measured in a way such that a mapping analysis of the analyzing surface is conducted on an energy dispersion spectroscopy, using a field effect-scanning transmission electron microscopy (FE-STEM), to detect a surface area of the crystal grain, contained in the analyzing surface, as a mapping dot image for thereby measuring a surface area covered by dots involved in the mapping dot image.

Further, the cross sectional area of the crystal grain appearing in the analyzing surface can be measured in another way. That is, a mapping analysis is conducted on the analyzing surface based on an electron energy loss spectrometry (EELS) using an energy filter transmission electron microscopy (EFTEM). This allows the surface area of the crystal grain, contained in the analyzing surface, to be detected as a mapping dot image for thereby measuring a surface area covered with the dots involved in the mapping dot image.

Furthermore, the cross sectional area of the crystal grain appearing in the analyzing surface can be measured in another way. That is, a mapping analysis is conducted on the analyzing surface based on a high angle annular dark field using the field effect-scanning transmission electron microscopy (FE-STEM). This allows the surface area of the crystal grain, contained in the analyzing surface, to be detected as a mapping dot image for thereby measuring a surface area covered with the dots involved in the mapping dot image.

As set forth above, the energy dispersion spectroscopy (EDS) using the field effect-scanning transmission electron microscopy (FE-STEM), the electron energy loss spectrometry (EELS) using the energy filter transmission electron microscopy (EFTEM) or the high angle annular dark field using the field effect-scanning transmission electron microscopy (FE-STEM) can detect elements such as metal elements forming the crystal grains in the analyzing surface. Accordingly, conducting the mapping analysis enables a dispersion state of the fine grains to be detected as, for instance, colored dots or the like in the mapping dot image. Therefore, the cross sectional area of the crystal grains in the analyzing surface can be accurately measured in a simple manner.

### Embodiment

An alumina compound sintered compact of an embodiment according to the present invention and a spark plug, incorporating such an alumina compound sintered compact as insulating material, for use in an internal combustion engine will be described below in detail with reference to FIGURE of the accompanying drawing.

As shown in FIGURE, the spark plug 1 of the present embodiment for use in the internal combustion engine comprises a metal shell 5 having a lower portion whose outer periphery formed with a mounting threaded portion 52, a porcelain insulator 2 fixedly held with the metal shell 5 and having an axial through-bore 25 and a leading end portion 21 axially extending from a leading end 51 of the metal shell 5, a center electrode 3 fixedly supported in the axial through-bore 25 of the porcelain insulator 2 in a central axis thereof, and a ground electrode 4 fixedly bonded to the leading end 51 of the cylindrical metal shell 5 to provide a spark discharge gap 10 with respect to a leading end portion 31 of the center electrode 3.

The mounting threaded portion 52 has a nominal diameter less than a value of “M10”.

The porcelain insulator 2 is comprised of the alumina compound sintered compact implementing the present invention.

The spark plug 1, applicable to an ignition plug of an automotive engine, is inserted to a threaded bore, formed in an engine block (not shown) defining a combustion chamber of the engine, and fixedly secured thereto.

The metal shall 5 of the spark plug 1 is comprised of a conductive cylindrical body made of, for instance, steel material such as low carbon steel or the like. The mounting threaded portion 52, formed on the outer periphery of the cylindrical metal shell 5, is adapted to be screwed to the threaded bore of the engine block. In the illustrated embodiment, the mounting threaded portion 52 has a nominal diameter less than 10 mm, i.e., “M10” under JIS (Japanese Industrial Standard).

The metal shall 5 internally accommodates the porcelain insulator 2 made of the alumina compound sintered compact implementing the present invention. The leading end portion 21 of the porcelain insulator 2 protrudes from the leading end 51 of the metal shell 5.

The center electrode 3 is disposed in and fixedly secured to the axial throughbore 25 of the porcelain insulator 2 such that the center electrode 3 is held in insulating property with respect to the metal shell 5.

The center electrode 3 includes a columnar body composed of an inner material layer, made of metallic material such as, for instance, copper or the like with excellent heat conductivity, and an outer material layer made of metallic material such as, for instance, nickel-based alloy or the like with excellent heat resistant and corrosion resistant properties.

As shown in FIGURE, the center electrode 3 has a cone-shaped nose portion 31 protruding from the leading end portion 21 of the porcelain insulator 2. Thus, the center electrode 3 is accommodated in the metal shell 5 with the cone-shaped nose portion 31 protruding from the leading end portion 21 of the porcelain insulator 2.

Meanwhile, the ground electrode 4 is made of Ni-based alloy having a principal component of, for instance, Ni and has a columnar shape. With the present embodiment, the ground electrode 4, formed in a square column shape, has a base end 4a bonded to the leading end 51 of the metal shell 5 by welding or the like, an intermediate portion 4b extending downward from the base end 4a and bent in a nearly “L”-shape, and a leading end portion 4c whose sidewall 41 is placed in face-to-face relationship with the cone-shaped nozzle portion 31 with the intervening spark discharge gap 10.

A noble metal tip 311 is bonded to the cone-shaped nozzle portion 31 of the center electrode body 3 and protrudes therefrom toward a noble metal chip 411 to define the spark discharge gap 10. In addition, the noble metal chip 411 is bonded to the sidewall 41 of the leading end portion 4c of the ground electrode 4 and protrudes in face-to-face relationship with the noble metal chip 311 of the center electrode 3.

The noble metal chips 311, 411, made of Ir (iridium) alloy or Pt (platinum) alloy or the like, are bonded to respective electrode base materials by laser welding or resistance welding or the like.

The spark discharge gap 10 is formed with an air gap defined with leading end faces of the noble metal chips 311, 411. The spark discharge gap 10 has a size dimensioned in the order of approximately, for instance, 1 mm.

Further, an extracting stem portion 17 for taking the center electrode 3 out of the porcelain insulator 2 is accommodated in the axial through-bore 25 of the porcelain insulator 2 at a position in opposition to the leading end portion 21 of the porcelain insulator 2. The extracting stem portion 17, formed in a bar-like configuration with electric conductivity, has a leading end 17a electrically connected to a base end 3a of the center electrode 3 via a conductive glass seal 18 in an area inside the axial through-bore 25 of the porcelain insulator 2.

As set forth above, the porcelain insulator 2 is comprised of the alumina compound sintered compact implementing the first aspect of the present invention.

The alumina compound sintered compact, containing alumina in a major proportion, is composed of alumina, mullite (3Al₂O₃.2SiO₂), zircon (ZrSiO₄), zirconia (ZrO₂) and the specified metal oxide composed of oxide of at least one element selected from Group III elements excepting Mg (magnesium), Ca (calcium), Sr (strontium), Ba (barium) and actinoid.

The alumina compound sintered compact contains 0.5 to 10 total parts by weight of mullite, zircon and zirconia, 0.5 to 10 parts by weight of the specified metal oxide and a balance substantially containing alumina based on 100 parts by weight in total.

More particularly, an example of the specified metal oxide may preferably include at least one oxide selected from the group consisting of MgO, CaO, SrO, BaO, Sc₂O₃, Y₂O₃, La₂O₃, CeO₂, Pr₂O₃, Pr₆O₁₁, Nd₂O₃, Pm₂O₃, Sm₂O₃, Eu₂O₃, Gd₂O₃, Tb₂O₃, Dy₂O₃, Ho₂O₃, Er₂O₃, Tm₂O₃, Yb₂O₃, and Lu₂O₃.

Further, alumina crystal grains, mullite crystal grains, zircon crystal grains, zirconia crystal grains and the specified metal oxide are dispersed in the alumina compound sintered compact. Analyzing surfaces include arbitrary regions each with a size of 100 μm×100 μm in a cross sectional area of the alumina compound sintered compact. For the neighboring analyzing surfaces in at least 20 sites, cross-sectional areas of crystal grains of the specified metal oxide, contained in each analyzing surface, were measured and an average cross-sectional area was calculated. Subsequently, the average cross-sectional area was converted into a circle with an equal surface area. In this case, a equivalent circle diameter had a value ranging from 0.2 μm to 4 μm.

The alumina compound sintered compact of the present embodiment has advantageous effects as described below.

The alumina compound sintered compact contains the specified metal oxide as described above. With the total of mullite, zircon and zirconia and the content of the specified metal oxide selected to have respective contents mentioned above, the alumina compound sintered compact can have an excellent withstanding voltage characteristic.

Although it's not known exactly why the inclusion of the respective components in such contents enables the achievement of such an excellent withstanding voltage characteristic, the reason can be conceived as described below.

In manufacturing the alumina compound sintered compact, a sintering step is conducted during which a reaction takes place between alumina and zircon. This results in the formation of mullite with the specified metal oxide being uniformly dispersed with a resultant crystallization of a grain boundary layer between the neighboring alumina crystal grains in which crystal grains of mullite, zircon and the specified metal oxide are formed. In addition, the specified metal oxide reacts with zircon, causing the crystallization of tetragonal zirconia. This precludes the occurrence of cracking resulting from a phase transformation caused during the sintering process, thereby obtaining an alumina compound sintered compact that is dense in structure. This results in a capability of suppressing the occurrence of defects caused in an internal structure, thereby ensuring the alumina compound sintered compact to have a high withstanding voltage.

Further, with 0.5 to 10 parts by weight of the specified metal oxides contained per 100 total parts by weight of the alumina compound sintered compact, none of mullite, zircon and zirconia and the specified metal oxide form independently coagulated crystals with the crystal grains dispersed in position. This prevents the alumina compound sintered compact from being formed with an electrically conductive path, ensuring a high withstanding voltage.

Furthermore, with the specified metal oxide selected to have the equivalent circle diameter ranging from 0.2 μm to 4 μm, the specified metal oxide can be dispersed in the alumina compound sintered compact in an adequately and uniformly dispersed pattern. This allows the alumina compound sintered compact to adequately have the advantageous effects mentioned above due to the addition of the specified metal oxide, enabling an effective increase in the withstanding voltage characteristic of the alumina compound sintered compact.

Moreover, the spark plug 1 of the present embodiment is made of alumina compound sintered compact as insulation material. Thus, the spark plug 1 incorporates the porcelain insulator 2 made of insulation material formed in a thinned wall layer. This provides an ease of miniaturizing the spark plug 1, thereby enabling the spark plug 1 to be easily miniaturized in structure.

Further, the spark plug 1 includes the porcelain insulator 2 incorporating the alumina compound sintered compact excellent in withstanding voltage characteristic. Therefore, even if the porcelain insulator 2 takes the form of a thinned wall layer, the spark plug 1 is capable of having an adequate withstanding voltage characteristic. This makes it easy to miniaturize the porcelain insulator 2 in structure, providing an ease of miniaturization of the spark plug 1.

Although the mounting threaded portion 52 of the spark plug 1 has the nominal diameter less than “M10”, the spark plug 1 formed in such a small diameter in a miniaturized dimension can ensure the formation of a miniaturized structure with an adequate withstanding voltage characteristic.

As set forth above, the present embodiment can provide the alumina compound sintered compact with the excellent withstanding voltage characteristic and the miniaturized spark plug 1 with the excellent withstanding voltage characteristic.

### FIRST EXAMPLE

In this Example, a specimen of the alumina compound sintered compact was manufactured for the purpose of conducting an evaluation on the withstanding voltage characteristic.

First, the specimen of the alumina compound sintered compact, composed of alumina, mullite (3Al₂O₃.2SiO₂), zircon (ZrSiO₄), zirconia (ZrO₂) and the specified metal oxide, was manufactured.

In manufacturing the specimen of the alumina compound sintered compact, the content of mullite, zircon and zirconia was set in values ranging from 0.5 to 10 total parts by weight with the content of the specified metal oxide set in values ranging from 0.5 to 10 parts by weight.

More particularly, description is made of the specimens of the alumina compound sintered compacts with reference to the specimen No. 17 designated in Table 1 described below.

First, a powder of alumina grains, made of alumina with purity greater than 99.9% and an average grain diameter ranging from 0.4 to 1.0 μm, and a powder of zircon grains, made of zircon with purity greater than 99.8% and an average grain diameter ranging from 0.4 to 1.0 μm, were prepared. In addition, a raw material powder of MgO with an average grain diameter of 100 nm was prepared.

The average grain diameter of a raw material powder of MgO is an average grain diameter that is obtained by observing 100 pieces of raw material powder grains of MgO using a transmission electron microscopy (TEM) upon which the diameters of 100 pieces of grains were arithmetically averaged.

Next, 93 parts by weight of alumina grain powder, 5 parts by weight of zircon grain powder and 2 parts by weight of MgO grain powder were dispersed in water, thereby preparing a raw material mixture slurry.

More particularly, first, 100 parts by weight of pure water was fed to a mixing tank, provided with a stirring blade, to which 5 parts by weight of zircon grains and 2 parts by weight of MgO grains were fed. The resulting blend was mixed and stirred with the stirring blade. During such a mixing and stirring step, the resulting dispersion liquid was adjusted to a pH value (hydrogen ion concentration) ranging from 8 to 10. This enabled the grains to have surface potentials (zeta potentials) controlled preventing the zircon grains and the MgO grains to repel each other to cause the coagulation of these compounds. In addition, selecting the pH value of dispersed liquid enabled the surface potentials of the grains to be arbitrarily selected.

Further, the mixing tank included ultrasonic transducer means. The ultrasonic transducer means functioned as means for defending the zircon grains and the MgO grains in dispersed liquid from coagulating with each other.

Next, 93 parts by weight of alumina grain powder and a suitable amount of binder were added to dispersed liquid in the mixing tank. The resulting mixture was stirred for more than 30 minutes, thereby preparing a raw material mixture slurry. Examples of binder include resin material such as, for instance, polyvinyl alcohol and acryl or the like. In addition, the resulting raw material mixture slurry was mixed using a high-speed rotary mixer for dispersion.

The high-speed rotary mixer includes a mixing chamber and a plurality of rotors mounted inside the mixing chamber to turn at a high speed higher than a peripheral speed of 20 m/second. As the raw material mixture slurry is introduced into the mixing chamber with the respective rotors turning at the high speeds, a high-speed swirling flow occurs in the raw material mixture slurry. The raw material mixture slurry passes through gaps each with a value of about 1 mm formed between neighboring rotors. In this moment, a shock wave occurs that suppresses the coagulation between a sintering additive and fine grains. This results in raw material mixture slurry containing the alumina grains, the zircon grains and the MgO grains that are dispersed in a uniform pattern.

Moreover, the operations were performed on three passes using the high-speed rotary mixer. As used herein, the term “1 pass” refers to a whole amount of raw material mixture slurry passes through the mixing chamber, provided with the high-speed rotary mixer, one time and “3 passes” refers to a case in which raw material mixture slurry passes through the mixing chamber three times.

The raw material mixture slurry, obtained in such a way mentioned above, had the grains dispersed in a further uniform pattern than that of slurry obtained in a related art mixing and dispersing method through the use of, for instance, a stirring mill or the like using a fixed media such as zirconia beads. With the related art mixing and dispersing method, if a crushing force is applied to an alumina particle, then, a variation occurs on a surface potential (zeta potential) of an alumina surface and an active surface occurs on a grain surface. This causes the zircon grains and the MgO grains to adhere onto the surfaces of the alumina grains due to an attraction force such as a mechanochemical effect, causing the grains to be easily coagulated.

Subsequently, the raw material mixture slurry, obtained in such a manner mentioned above, was dried in granulation spray drying, thereby obtaining granulated grains. Then, the granulated grains were shaped in a profile of an insulator, thereby obtaining a compact body. Thereafter, the compact body was fired, thereby obtaining an alumina compound sintered compact, formed in the profile of the insulator, as the porcelain insulator 2.

Other specimens were manufactured in conjunction with the manufacturing method described above to obtain 169 kinds of alumina compound sintered compacts (described in Tables 1 to 6) under conditions in which: MgO was blended in varying blending ratios and other the specified metal oxides excepting metal oxide of MgO; a firing condition (such as temperatures and times) was altered with a firing temperature ranging from 1300 to 1600° C. and a firing time ranging from 1 to 3 hours.

TABLE 1

| | Unit: wt % | | | | |
|---|---|---|---|---|---|
| | Zircon + | Unit: | | Withstand. | |
| Spec. | Mullite + | wt % | Unit: wt % | Voltage | |
| No | Zirconia | MgO | Alumina | (KV/mm) | |
| 1 | 15 | 10 | 75 | 33 | Out of Range |
| 2 | 10 | 10 | 80 | 36 | |
| 3 | 5 | 10 | 85 | 37 | |
| 4 | 2 | 10 | 88 | 37 | |
| 5 | 1 | 10 | 89 | 36 | |
| 6 | 0.5 | 10 | 89.5 | 35 | |
| 7 | 0.2 | 10 | 89.8 | 34 | Out of Range |
| 8 | 15 | 5 | 80 | 34 | Out of Range |
| 9 | 10 | 5 | 85 | 38 | |
| 10 | 5 | 5 | 90 | 39 | |
| 11 | 2 | 5 | 93 | 39 | |
| 12 | 1 | 5 | 94 | 38 | |
| 13 | 0.5 | 5 | 94.5 | 37 | |
| 14 | 0.2 | 5 | 94.8 | 34 | Out of Range |
| 15 | 15 | 2 | 83 | 34 | Out of Range |
| 16 | 10 | 2 | 88 | 39 | |
| 17 | 5 | 2 | 93 | 40 | |
| 18 | 2 | 2 | 96 | 39 | |
| 19 | 1 | 2 | 97 | 38 | |
| 20 | 0.5 | 2 | 97.5 | 35 | |
| 21 | 0.2 | 2 | 97.8 | 33 | Out of Range |
| 22 | 15 | 1 | 84 | 34 | Out of Range |
| 23 | 10 | 1 | 89 | 38 | |
| 24 | 5 | 1 | 94 | 38 | |
| 25 | 2 | 1 | 97 | 38 | |
| 26 | 1 | 1 | 98 | 37 | |
| 27 | 0.5 | 1 | 98.5 | 36 | |
| 28 | 0.2 | 1 | 98.8 | 34 | Out of Range |
| 29 | 15 | 0.5 | 84.5 | 32 | Out of Range |
| 30 | 10 | 0.5 | 89.5 | 35 | |
| 31 | 5 | 0.5 | 94.5 | 36 | |
| 32 | 2 | 0.5 | 97.5 | 36 | |
| 33 | 1 | 0.5 | 98.5 | 35.5 | |
| 34 | 0.5 | 0.5 | 99 | 35 | |
| 35 | 0.2 | 0.5 | 99.3 | 34 | Out of Range |

TABLE 2

| | Unit: wt % | | | | |
|---|---|---|---|---|---|
| | Zircon + | Unit: | | Withstand. | |
| Spec. | Mullite + | wt % | Unit: wt % | Voltage | |
| No | Zirconia | CaO | Alumina | (KV/mm) | |
| 36 | 15 | 10 | 75 | 32 | Out of Range |
| 37 | 10 | 10 | 80 | 35 | |
| 38 | 5 | 10 | 85 | 37 | |
| 39 | 2 | 10 | 88 | 37 | |
| 40 | 1 | 10 | 89 | 36 | |
| 41 | 0.5 | 10 | 89.5 | 35 | |
| 42 | 0.2 | 10 | 89.8 | 34 | Out of Range |
| 43 | 15 | 5 | 80 | 33 | Out of Range |
| 44 | 10 | 5 | 85 | 39 | |
| 45 | 5 | 5 | 90 | 39 | |
| 46 | 2 | 5 | 93 | 39 | |
| 47 | 1 | 5 | 94 | 38 | |
| 48 | 0.5 | 5 | 94.5 | 36 | |
| 49 | 0.2 | 5 | 94.8 | 34 | Out of Range |
| 50 | 15 | 2 | 83 | 33 | Out of Range |
| 51 | 10 | 2 | 88 | 37 | |
| 52 | 5 | 2 | 93 | 40 | |
| 53 | 2 | 2 | 96 | 40 | |
| 54 | 1 | 2 | 97 | 39 | |
| 55 | 0.5 | 2 | 97.5 | 36 | |
| 56 | 0.2 | 2 | 97.8 | 33 | Out of Range |
| 57 | 15 | 1 | 84 | 34 | Out of Range |
| 58 | 10 | 1 | 89 | 38 | |
| 59 | 5 | 1 | 94 | 40 | |
| 60 | 2 | 1 | 97 | 39 | |
| 61 | 1 | 1 | 98 | 38 | |
| 62 | 0.5 | 1 | 98.5 | 37 | |
| 63 | 0.2 | 1 | 98.8 | 34.5 | Out of Range |
| 64 | 15 | 0.5 | 84.5 | 34 | Out of Range |
| 65 | 10 | 0.5 | 89.5 | 37 | |
| 66 | 5 | 0.5 | 94.5 | 38 | |
| 67 | 2 | 0.5 | 97.5 | 37 | |
| 68 | 1 | 0.5 | 98.5 | 36 | |
| 69 | 0.5 | 0.5 | 99 | 35 | |
| 70 | 0.2 | 0.5 | 99.3 | 34 | Out of Range |

TABLE 3

| | Unit: wt % | | | | |
|---|---|---|---|---|---|
| | Zircon + | Unit: | | Withstand. | |
| Spec. | Mullite + | wt % | Unit: wt % | Voltage | |
| No | Zirconia | Y₂O₃ | Alumina | (KV/mm) | |
| 71 | 15 | 10 | 75 | 34 | Out of Range |
| 72 | 10 | 10 | 80 | 37 | |
| 73 | 5 | 10 | 85 | 38 | |
| 74 | 2 | 10 | 88 | 38 | |
| 75 | 1 | 10 | 89 | 36 | |
| 76 | 0.5 | 10 | 89.5 | 35 | |
| 77 | 0.2 | 10 | 89.8 | 34 | Out of Range |
| 78 | 15 | 5 | 80 | 34 | Out of Range |
| 79 | 10 | 5 | 85 | 39 | |
| 80 | 5 | 5 | 90 | 40 | |
| 81 | 2 | 5 | 93 | 40 | |
| 82 | 1 | 5 | 94 | 39 | |
| 83 | 0.5 | 5 | 94.5 | 37 | |
| 84 | 0.2 | 5 | 94.8 | 34 | Out of Range |
| 85 | 15 | 2 | 83 | 34.5 | Out of Range |
| 86 | 10 | 2 | 88 | 40 | |
| 87 | 5 | 2 | 93 | 41 | |
| 88 | 2 | 2 | 96 | 41 | |
| 89 | 1 | 2 | 97 | 39 | |
| 90 | 0.5 | 2 | 97.5 | 36 | |
| 91 | 0.2 | 2 | 97.8 | 33 | Out of Range |
| 92 | 15 | 1 | 84 | 34.5 | Out of Range |
| 93 | 10 | 1 | 89 | 39 | |
| 94 | 5 | 1 | 94 | 40 | |
| 95 | 2 | 1 | 97 | 40 | |
| 96 | 1 | 1 | 98 | 39 | |
| 97 | 0.5 | 1 | 98.5 | 36 | |
| 98 | 0.2 | 1 | 98.8 | 33 | Out of Range |
| 99 | 15 | 0.5 | 84.5 | 34 | Out of Range |
| 100 | 10 | 0.5 | 89.5 | 38 | |
| 101 | 5 | 0.5 | 94.5 | 39 | |
| 102 | 2 | 0.5 | 97.5 | 39 | |
| 103 | 1 | 0.5 | 98.5 | 38 | |
| 104 | 0.5 | 0.5 | 99 | 36 | |
| 105 | 0.2 | 0.5 | 99.3 | 34 | Out of Range |

TABLE 4

| | Unit: wt % | | | |
|---|---|---|---|---|
| Spec. | Zircon + | Unit: | Unit: wt % | Withstand. Voltage |
| No | Mullite + Zirconia | wt % | Alumina | (KV/mm) |
| | | MgO | | |
| 106 | 5 | 5 | 90.0 | 39 |
| 107 | 5 | 2 | 93.0 | 40 |
| 108 | 5 | 1 | 94.0 | 38 |
| 109 | 5 | 0.5 | 94.5 | 36 |
| | | CaO | | |
| 110 | 5 | 5 | 90.0 | 39 |
| 111 | 5 | 2 | 93.0 | 40 |
| 112 | 5 | 1 | 94.0 | 40 |
| 113 | 5 | 0.5 | 94.5 | 38 |
| | | SrO | | |
| 114 | 5 | 5 | 90.0 | 37 |
| 115 | 5 | 2 | 93.0 | 40 |
| 116 | 5 | 1 | 94.0 | 40 |
| 117 | 5 | 0.5 | 94.5 | 38 |
| | | BaO | | |
| 118 | 5 | 5 | 90.0 | 37 |
| 119 | 5 | 2 | 93.0 | 40 |
| 120 | 5 | 1 | 94.0 | 39 |
| 121 | 5 | 0.5 | 94.5 | 38 |
| | | Sc₂O₃ | | |
| 122 | 5 | 5 | 90.0 | 37 |
| 123 | 5 | 2 | 93.0 | 39 |
| 124 | 5 | 1 | 94.0 | 40 |
| 125 | 5 | 0.5 | 94.5 | 38 |
| | | Y₂O₃ | | |
| 126 | 5 | 5 | 90.0 | 40 |
| 127 | 5 | 2 | 93.0 | 41 |
| 128 | 5 | 1 | 94.0 | 40 |
| 129 | 5 | 0.5 | 94.5 | 39 |
| | | La₂O₃ | | |
| 130 | 5 | 5 | 90.0 | 40 |
| 131 | 5 | 2 | 93.0 | 40 |
| 132 | 5 | 1 | 94.0 | 40 |
| 133 | 5 | 0.5 | 94.5 | 39 |

TABLE 5

| | Unit: wt % | | | |
|---|---|---|---|---|
| Spec. | Zircon + | Unit: | Unit: wt % | Withstand. Voltage |
| No | Mullite + Zirconia | wt % | Alumina | (KV/mm) |
| | | CeO₂ | | |
| 134 | 5 | 5 | 90.0 | 38 |
| 135 | 5 | 2 | 93.0 | 39 |
| 136 | 5 | 1 | 94.0 | 39 |
| 137 | 5 | 0.5 | 94.5 | 36 |
| | | Pr₆O₁₁ | | |
| 138 | 5 | 5 | 90.0 | 40 |
| 139 | 5 | 2 | 93.0 | 40 |
| 140 | 5 | 1 | 94.0 | 40 |
| 141 | 5 | 0.5 | 94.5 | 39 |
| | | Nd₂O₃ | | |
| 142 | 5 | 5 | 90.0 | 40 |
| 143 | 5 | 2 | 93.0 | 40 |
| 144 | 5 | 1 | 94.0 | 40 |
| 145 | 5 | 0.5 | 94.5 | 39 |
| | | Sm₂O₃ | | |
| 146 | 5 | 5 | 90.0 | 40 |
| 147 | 5 | 2 | 93.0 | 41 |
| 148 | 5 | 1 | 94.0 | 40 |
| 149 | 5 | 0.5 | 94.5 | 39 |
| | | Dy₂O₃ | | |
| 150 | 5 | 5 | 90.0 | 40 |
| 151 | 5 | 2 | 93.0 | 41 |
| 152 | 5 | 1 | 94.0 | 40 |
| 153 | 5 | 0.5 | 94.5 | 39 |
| | | Lu₂O₃ | | |
| 154 | 5 | 5 | 90.0 | 40 |
| 155 | 5 | 2 | 93.0 | 41 |
| 156 | 5 | 1 | 94.0 | 40 |
| 157 | 5 | 0.5 | 94.5 | 39 |

TABLE 6

| | Unit: wt % | | | Withstand. |
|---|---|---|---|---|
| Spec. | Zircon + | | Unit: wt % | Voltage |
| No | Mullite + Zirconia | Unit: wt % | Alumina | (KV/mm) |
| | | MgO + CaO | | |
| | | (1:1(by wt %)) | | |
| 158 | 5 | 2 | 93 | 40 |
| | | CaO + Y₂O₃ | | |
| | | (1:1(by wt %)) | | |
| 159 | 5 | 2 | 93 | 41 |
| | | CaO + SrO | | |
| | | (1:1(by wt %)) | | |
| 160 | 5 | 2 | 93 | 40 |
| | | CaO + BaO | | |
| | | (1:1(by wt %)) | | |
| 161 | 5 | 2 | 93 | 40 |
| | | CaO + Sc₂O₃ | | |
| | | (1:1(by wt %)) | | |
| 162 | 5 | 2 | 93 | 40 |
| | | CaO + La₂O₃ | | |
| | | (1:1(by wt %)) | | |
| 163 | 5 | 2 | 93 | 40 |
| | | CaO + CeO₂ | | |
| | | (1:1(by wt %)) | | |
| 164 | 5 | 2 | 93 | 39 |
| | | CaO + Pr₆O₁₁ | | |
| | | (1:1(by wt %)) | | |
| 165 | 5 | 2 | 93 | 40 |
| | | CaO + Nd₂O₃ | | |
| | | (1:1 (by wt %)) | | |
| 166 | 5 | 2 | 93 | 40 |
| | | CaO + Sm₂O₃ | | |
| | | (1:1(by wt %)) | | |
| 167 | 5 | 2 | 93 | 40 |
| | | CaO + Dy₂O₃ | | |
| | | (1:1(by wt %)) | | |
| 168 | 5 | 2 | 93 | 40 |
| | | CaO + Lu₂O₃ | | |
| | | (1:1(by wt %)) | | |
| 169 | 5 | 2 | 93 | 40 |

In this Example, the specimens, of the present embodiment were manufactured in various structures with the total content of mullite, zircon and zirconia and the content of the specified metal oxide altered in various blending ratios within a range of the present invention. For comparison purposes, alumina compound sintered compacts were also manufactured as specimens with a total content of mullite, zircon and zirconia laying in a value outside the range from 0.5 to 10 parts by weight. The alumina compound sintered compacts for such comparison purposes were manufactured in the same composition as that of the other specimens excepting the total content of mullite, zircon and zirconia.

The alumina compound sintered compacts for such comparison purposes include the specimens, designated as “Out of Range” in Tables 1 to 3, which correspond to the specimens Nos. 7, 8, 14, 15, 21, 22, 28, 29, 35, 36, 42, 43, 49, 50, 56, 57, 63, 64, 70, 71, 77, 78, 84, 85, 91, 92, 98, 99 and 105.

Next, the withstanding voltages of the alumina compound sintered compacts, designated as the specimens Nos. 1 to 169, were measured using a withstanding voltage measuring device.

More particularly, an internal electrode of the withstanding voltage measuring device was inserted to each of the alumina compound sintered compacts formed in a shape of the porcelain insulator. Further, an outer electrode, formed in a circular ring-shape, was fitted to an outer periphery of each of the alumina compound sintered compact bodies such that both of the electrodes were located in positions with measuring points laying in a thickness of the alumina compound sintered compact with a range of 1.0±0.05 mm at all times.

Then, a high voltage is applied across the inner electrode and the outer electrode from a constant-voltage power supply through an oscillator and a coil. In this moment, the voltage was raised by 1 kV/second at a frequency of 30 cycles/second while monitoring voltage levels on an oscilloscope. Then, voltage levels, causing a dielectric breakdown to occur in the alumina compound sintered compacts, were measured and regarded as the withstanding voltages. The results are shown in Tables 1 to 6.

As will be seen from Tables 1 to 6, it is turned out that the specimens of the alumina compound sintered compact, implementing the present invention, ensure the withstanding voltage at levels higher than 35 kV/mm. On the contrary, it is turned out that the specimens of the alumina compound sintered compact, uninvolved in the present invention and containing mullite, zircon and zirconia in the total content with a value out of the range from 0.5 to 10 parts by weight, had the withstanding voltage at levels lower than 34 kV/mm due to a drop in the withstanding voltage.

### SECOND EXAMPLE

In this Example, a plurality of alumina compound sintered compacts was manufactured as specimens Nos. 170 to 286 with different diameters of circles of fine grains (equivalent circle diameters of fine grains). Each of the circles was obtained by allocating arbitrary areas, each with a surface of 100 μm×100 μm in cross section of each of the alumina compound sintered compacts, as analyzing surfaces and measuring cross-sectional areas of respective fine grains of the specified metal oxides, contained in neighboring analyzing surfaces in at least 20 points, for calculating an average cross-sectional area for conversion into the circle in an equal surface area.

In this Example, first, the alumina compound sintered compacts (specimens Nos. 170 to 286) were manufactured each in composition containing the crystals composed of the specified metal oxide composed of MgO or the like with the fine grains having different equivalent circle diameters.

Then, the equivalent circle diameter of the specified metal oxide, i.e., oxide of at least one element selected from Group III elements excepting Mg (Magnesium), Ca (calcium), Sr (strontium), Ba (Barium) and actinoid, of each of the respective specimens (Specimen Nos. 170 to 286) was measured.

In measuring the equivalent circle diameter, the arbitrary area with 100 μm×100 μm in cross section of each specimen was regarded to be the analyzing surface. Then, the cross-sectional areas of respective fine grains of the specified metal oxide contained in at least the neighboring analyzing surfaces at 20 points were measured upon conducting a mapping analysis with the energy dispersion spectroscopy (EDS) using the field effect-scanning transmission electron microscopy (FE-STEM). This allowed the cross-sectional areas of the fine grains to be detected as a mapping dot image (color dot image). Then, unit grains (primary grains) or aggregate grains (secondary grain) in 20 points of the analyzing surfaces were observed in the mapping dot image (color dot image). The unit grains or the aggregate grains of the fine grains in the mapping dot image were discriminated as polygonal shapes, thereby obtaining the surfaces areas of the same. Using software (such as, for instance, “WinROOF” manufactured and sold by Mitani Shouji Co., Ltd), coordinating an image processing-image measuring-data processing, allows the surface area to be measured. The resulting surface area was converted into a circle equivalent in surface area to the resulting surface to obtain a diameter of the resulting circle, which diameter was regarded to be the equivalent circle diameter of the grain. The equivalent circle diameter was obtained as an average of all the grains of the specified metal oxide.

The withstanding voltages of these specimens were measured in the same way as that conducted in the first Example. The results are indicated in Tables 7 to 13.

TABLE 7

| | | | | Equivalent | |
|---|---|---|---|---|---|
| | | | | Circle | |
| | | | | Diameter | |
| | | | | (μm) of | |
| Spec. | Composition (by wt %) of Alumina | | | Crystal | Withstand. |
| No | Compound Sintered Compact | | | Grains | Voltage |
| | Zircon + Mullite + | | | | |
| | Zirconia | MgO | Alumina | MgO | (KV/mm) |
| 170 | 5 | 2 | 93 | 0.1 | 32 |
| 171 | 5 | 2 | 93 | 0.2 | 35 |
| 172 | 5 | 2 | 93 | 0.3 | 39 |
| 173 | 5 | 2 | 93 | 1 | 40 |
| 174 | 5 | 2 | 93 | 2 | 40 |
| 175 | 5 | 2 | 93 | 4 | 38 |
| 176 | 5 | 2 | 93 | 5 | 33 |
| 177 | 5 | 2 | 93 | 6 | 30 |
| 178 | 5 | 2 | 93 | 8 | 29 |
| | Zircon + | | | | |
| | Mullite + Zirconia | CaO | Alumina | CaO | (KV/mm) |
| 179 | 5 | 2 | 93 | 0.1 | 32 |
| 180 | 5 | 2 | 93 | 0.2 | 35 |
| 181 | 5 | 2 | 93 | 0.3 | 39 |
| 182 | 5 | 2 | 93 | 1 | 40 |
| 183 | 5 | 2 | 93 | 2 | 40 |
| 184 | 5 | 2 | 93 | 4 | 38 |
| 185 | 5 | 2 | 93 | 5 | 33 |
| 186 | 5 | 2 | 93 | 6 | 30 |
| 187 | 5 | 2 | 93 | 8 | 29 |

TABLE 8

| | | | | Equivalent | |
|---|---|---|---|---|---|
| | | | | Circle | |
| | | | | Diameter | |
| | | | | (μm) of | |
| Spec. | Composition (by wt %) of Alumina | | | Crystal | Withstand. |
| No | Compound Sintered Compact | | | Grains | Voltage |
| | Zircon + Mullite + | | | | |
| | Zirconia | SrO | Alumina | SrO | (KV/mm) |
| 188 | 5 | 2 | 93 | 0.1 | 32 |
| 189 | 5 | 2 | 93 | 0.2 | 35 |
| 190 | 5 | 2 | 93 | 0.3 | 39 |
| 191 | 5 | 2 | 93 | 1 | 40 |
| 192 | 5 | 2 | 93 | 2 | 40 |
| 193 | 5 | 2 | 93 | 4 | 38 |
| 194 | 5 | 2 | 93 | 5 | 33 |
| 195 | 5 | 2 | 93 | 6 | 30 |
| 196 | 5 | 2 | 93 | 8 | 29 |
| | Zircon + Mullite + | | | | |
| | Zirconia | BaO | Alumina | BaO | (KV/mm) |
| 197 | 5 | 2 | 93 | 0.1 | 32 |
| 198 | 5 | 2 | 93 | 0.2 | 35 |
| 199 | 5 | 2 | 93 | 0.3 | 39 |
| 200 | 5 | 2 | 93 | 1 | 40 |
| 201 | 5 | 2 | 93 | 2 | 40 |
| 202 | 5 | 2 | 93 | 4 | 39 |
| 203 | 5 | 2 | 93 | 5 | 33 |
| 204 | 5 | 2 | 93 | 6 | 30 |
| 205 | 5 | 2 | 93 | 8 | 29 |

TABLE 9

| | | | | Equivalent | |
|---|---|---|---|---|---|
| | | | | Circle | |
| | | | | Diameter | |
| | | | | (μm) of | |
| Spec. | Composition (by wt %) of Alumina | | | Crystal | Withstand. |
| No | Compound Sintered Compact | | | Grains | Voltage |
| | Zircon + Mullite + | | | | |
| | Zirconia | Sc₂O₃ | Alumina | Sc₂O₃ | (KV/mm) |
| 206 | 5 | 2 | 93 | 0.1 | 32 |
| 207 | 5 | 2 | 93 | 0.2 | 35 |
| 208 | 5 | 2 | 93 | 0.3 | 38 |
| 209 | 5 | 2 | 93 | 1 | 39 |
| 210 | 5 | 2 | 93 | 2 | 39 |
| 211 | 5 | 2 | 93 | 4 | 38 |
| 212 | 5 | 2 | 93 | 5 | 34 |
| 213 | 5 | 2 | 93 | 6 | 30 |
| 214 | 5 | 2 | 93 | 8 | 29 |
| | Zircon + Mullite + | | | | |
| | Zirconia | Y₂O₃ | Alumina | Y₂O₃ | (KV/mm) |
| 215 | 5 | 2 | 93 | 0.1 | 33 |
| 216 | 5 | 2 | 93 | 0.2 | 36 |
| 217 | 5 | 2 | 93 | 0.3 | 39 |
| 218 | 5 | 2 | 93 | 1 | 41 |
| 219 | 5 | 2 | 93 | 2 | 41 |
| 220 | 5 | 2 | 93 | 4 | 39 |
| 221 | 5 | 2 | 93 | 5 | 33 |
| 222 | 5 | 2 | 93 | 6 | 30 |
| 223 | 5 | 2 | 93 | 8 | 29 |

TABLE 10

| | | | | Equivalent | |
|---|---|---|---|---|---|
| | | | | Circle | |
| | | | | Diameter | |
| | | | | (μm) of | |
| Spec. | Composition (by wt %) of Alumina | | | Crystal | Withstand. |
| No | Compound Sintered Compact | | | Grains | Voltage |
| | Zircon + Mullite + | | | | |
| | Zirconia | La₂O₃ | Alumina | La₂O₃ | (KV/mm) |
| 224 | 5 | 2 | 93 | 0.1 | 32 |
| 225 | 5 | 2 | 93 | 0.2 | 35 |
| 226 | 5 | 2 | 93 | 0.3 | 39 |
| 227 | 5 | 2 | 93 | 1 | 40 |
| 228 | 5 | 2 | 93 | 2 | 40 |
| 229 | 5 | 2 | 93 | 4 | 38 |
| 230 | 5 | 2 | 93 | 5 | 33 |
| 231 | 5 | 2 | 93 | 6 | 30 |
| 232 | 5 | 2 | 93 | 8 | 29 |
| | Zircon + Mullite + | | | | |
| | Zirconia | CeO₂ | Alumina | CeO₂ | (KV/mm) |
| 233 | 5 | 2 | 93 | 0.1 | 32 |
| 234 | 5 | 2 | 93 | 0.2 | 35 |
| 235 | 5 | 2 | 93 | 0.3 | 38 |
| 236 | 5 | 2 | 93 | 1 | 39 |
| 237 | 5 | 2 | 93 | 2 | 39 |
| 238 | 5 | 2 | 93 | 4 | 36 |
| 239 | 5 | 2 | 93 | 5 | 30 |
| 240 | 5 | 2 | 93 | 6 | 28 |
| 241 | 5 | 2 | 93 | 8 | 27 |

TABLE 11

| | | | | Equivalent | |
|---|---|---|---|---|---|
| | | | | Circle | |
| | | | | Diameter | |
| | | | | (μm) of | |
| Spec. | Composition (by wt %) of Alumina | | | Crystal | Withstand. |
| No | Compound Sintered Compact | | | Grains | Voltage |
| | Zircon + Mullite + | | | | |
| | Zirconia | Pr₆O₁₁ | Alumina | Pr₆O₁₁ | (KV/mm) |
| 242 | 5 | 2 | 93 | 0.1 | 32 |
| 243 | 5 | 2 | 93 | 0.2 | 35 |
| 244 | 5 | 2 | 93 | 0.3 | 39 |
| 245 | 5 | 2 | 93 | 1 | 40 |
| 246 | 5 | 2 | 93 | 2 | 40 |
| 247 | 5 | 2 | 93 | 4 | 37 |
| 248 | 5 | 2 | 93 | 5 | 33 |
| 249 | 5 | 2 | 93 | 6 | 29 |
| 250 | 5 | 2 | 93 | 8 | 28 |
| | Zircon + Mullite + | | | | |
| | Zirconia | Nd₂O₃ | Alumina | Nd₂O₃ | (KV/mm) |
| 251 | 5 | 2 | 93 | 0.1 | 32 |
| 252 | 5 | 2 | 93 | 0.2 | 35 |
| 253 | 5 | 2 | 93 | 0.3 | 39 |
| 254 | 5 | 2 | 93 | 1 | 40 |
| 255 | 5 | 2 | 93 | 2 | 40 |
| 256 | 5 | 2 | 93 | 4 | 37 |
| 257 | 5 | 2 | 93 | 5 | 32 |
| 258 | 5 | 2 | 93 | 6 | 29 |
| 259 | 5 | 2 | 93 | 8 | 28 |

TABLE 12

| | | | | Equivalent | |
|---|---|---|---|---|---|
| | | | | Circle | |
| | | | | Diameter | |
| | | | | (μm) of | |
| Spec. | Composition (by wt %) of Alumina | | | Crystal | Withstand. |
| No | Compound Sintered Compact | | | Grains | Voltage |
| | Zircon + Mullite + | | | | |
| | Zirconia | Sm₂O₃ | Alumina | Sm₂O₃ | (KV/mm) |
| 260 | 5 | 2 | 93 | 0.1 | 33 |
| 261 | 5 | 2 | 93 | 0.2 | 36 |
| 262 | 5 | 2 | 93 | 0.3 | 39 |
| 263 | 5 | 2 | 93 | 1 | 41 |
| 264 | 5 | 2 | 93 | 2 | 41 |
| 265 | 5 | 2 | 93 | 4 | 39 |
| 266 | 5 | 2 | 93 | 5 | 33 |
| 267 | 5 | 2 | 93 | 6 | 30 |
| 268 | 5 | 2 | 93 | 8 | 29 |
| | Zircon + Mullite + | | | | |
| | Zirconia | Dy₂O₃ | Alumina | Dy₂O₃ | (KV/mm) |
| 269 | 5 | 2 | 93 | 0.1 | 33 |
| 270 | 5 | 2 | 93 | 0.2 | 36 |
| 271 | 5 | 2 | 93 | 0.3 | 39 |
| 272 | 5 | 2 | 93 | 1 | 41 |
| 273 | 5 | 2 | 93 | 2 | 41 |
| 274 | 5 | 2 | 93 | 4 | 38 |
| 275 | 5 | 2 | 93 | 5 | 33 |
| 276 | 5 | 2 | 93 | 6 | 30 |
| 277 | 5 | 2 | 93 | 8 | 29 |

TABLE 13

| | | | | Equivalent | |
|---|---|---|---|---|---|
| | | | | Circle | |
| | | | | Diameter | |
| | Composition (by wt %) of Alumina | | | (μm) of | |
| | Compound Sintered Compact | | | Crystal | Withstand. |
| Spec. | Zircon + Mullite + | | | Grains | Voltage |
| No | Zirconia | Lu₂O₃ | Alumina | Lu₂O₃ | (KV/mm) |
| 278 | 5 | 2 | 93 | 0.1 | 33 |
| 279 | 5 | 2 | 93 | 0.2 | 36 |
| 280 | 5 | 2 | 93 | 0.3 | 39 |
| 281 | 5 | 2 | 93 | 1 | 41 |
| 282 | 5 | 2 | 93 | 2 | 41 |
| 283 | 5 | 2 | 93 | 4 | 39 |
| 284 | 5 | 2 | 93 | 5 | 33 |
| 285 | 5 | 2 | 93 | 6 | 30 |
| 286 | 5 | 2 | 93 | 8 | 29 |

As will be apparent from Tables 7 to 13, the respective specimens (Specimen Nos. 171 to 175, Specimen Nos. 180 to 184, Specimen Nos. 189 to 193, Specimen Nos. 198 to 202, Specimen Nos. 207 to 211, Specimen Nos. 216 to 220, Specimen Nos. 225 to 229, Specimen Nos. 234 to 238, Specimen Nos. 243 to 247, Specimen Nos. 252 to 256, Specimen Nos. 261 to 265, Specimen Nos. 270 to 274 and Specimen Nos. 279 to 283), containing oxide of at least one element selected from Group III elements excepting Mg (Magnesium), Ca (calcium), Sr (strontium), Ba (Barium) and actinoid, had the equivalent circle diameter ranging from 0.2 to 4 μm while exhibiting a high withstanding voltage higher than 35 kV. More preferably, the fine grain may have the equivalent circle diameter ranging from 0.3 to 2 μm and, in this case, a higher withstanding voltage greater than 37 kV can be exhibited. The alumina compound sintered compact, exhibiting such a high withstanding voltage, is suitably applicable to a porcelain insulator of a spark plug, enabling the spark plug to be miniaturized.

While the specific embodiment of the present invention has been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. An alumina compound sintered compact containing alumina as a principal component, comprising:
alumina, mullite, zircon, zirconia and the specified metal oxide composed of an oxide of at least one element selected from Group III elements excepting Mg, Ca, Sr, Ba and actinoid;
wherein the alumina compound sintered compact contains 0.5 to 10 total parts by weight of mullite, zircon and zirconia, 0.5 to 10 total parts by weight of the specified metal oxide and a balance of substantially alumina based on 100 parts by weight in total.

2. The alumina compound sintered compact according to claim 1, wherein:
the specified metal oxide includes at least one element selected from the group consisting of MgO, CaO, SrO, BaO, Sc₂O₃, Y₂O₃, La₂O₃, CeO₂, Pr₂O₃, Pr₆O₁₁, Nd₂O₃, Pm₂O₃, Sm₂O₃, Eu₂O₃, Gd₂O₃, Tb₂O₃, Dy₂O₃, Ho₂O₃, Er₂O₃, Tm₂O₃, Yb₂O₃ and Lu₂O_{3.}

3. The alumina compound sintered compact according to claim 1, wherein:
alumina crystal grains, mullite crystal grains, zircon crystal grains, zirconia crystal grains and crystal grains of the specified metal oxide are dispersed in the alumina compound sintered compact, having a cross section including an arbitrary region with a surface of 100 μm×100 μm regarded as an analyzing surface upon which cross-sectional areas of respective fine grains of the specified metal oxide contained in at least the neighboring analyzing surfaces at 20 points are measured for calculating an average cross-sectional area converted to a circle in an equal surface area with a diameter representing an equivalent circle diameter ranging from 0.2 to 4 μm.

4. A spark plug for an internal combustion engine employing the alumina compound sintered compact according to claim 1 as insulation material.

5. A spark plug for an internal combustion engine, having a metal shell having an outer circumferential periphery formed with a mounting threaded portion, a porcelain insulator fixedly secured to the metal shell, a center electrode fixedly supported in the porcelain insulator and having a leading end portion protruding from the porcelain insulator, and a ground electrode bonded to the metal shell and having a leading end placed in face-to-face relationship with the leading end portion of the center electrode to provide a spark discharge gap;
wherein the mounting threaded portion has a nominal diameter less than M10; and
wherein the porcelain insulator is composed of the alumina compound sintered compact according to claim 1.

6. A method of manufacturing an alumina compound sintered compact having a principal component of alumina, comprising the steps of:
preparing alumina raw material in a major component, zircon raw material, and raw material of the specified metal oxide representing an oxide of at least one element selected from Group III elements excepting Mg, Ca, Sr, Ba and actinoid;
dispersing and mixing the raw materials in dispersion medium for preparing raw material mixture slurry;
granulating the raw material mixture slurry to be formed in granulated objects;
firing the granulated objects at temperatures equal to and above 1300° C. and equal to and less than 1600° C. for thereby obtaining the alumina compound sintered compact composed of alumina, mullite, zircon, zirconia and the specified metal oxide.

7. An alumina compound sintered compact containing alumina as a principal component, comprising:
alumina, mullite, zircon, zirconia and the specified metal oxide composed of an oxide of at least one element selected from Group III elements excepting Mg, Ca, Sr, Ba and actinoid;
wherein the alumina compound sintered compact contains 0.5 to 10 total parts by weight of mullite, zircon and zirconia, 0.5 to 10 total parts by weight of the specified metal oxide and a balance of substantially alumina based on 100 parts by weight in total; and
wherein the specified metal oxide is uniformly dispersed in mullite, resulting from a reaction between alumina and zircon, to form a grain boundary phase between neighboring alumina crystal grains in a crystal phase while forming crystals of mullite, zircon and the specified metal oxide.

8. The alumina compound sintered compact according to claim 7, wherein:
the grain boundary phase has tetragonal zirconia formed upon reaction with the specified metal oxide and zircon.
